(19) United States
(12) Patent Application Publication
(10) Pub. No.: US 2013/0185116 A1
(43) Pub. Date: Jul. 18, 2013

(54) AUTOMATIC DEMAND PARAMETER ESCALATION

(71) Applicants: Yevgeniy Popkov, Brookline, MA (US); Su-Ming Wu, Waltham, MA (US)

(72) Inventors: Yevgeniy Popkov, Brookline, MA (US); Su-Ming Wu, Waltham, MA (US)

(73) Assignee: ORACLE INTERNATIONAL CORPORATION, Redwood Shores, CA (US)

(21) Appl. No.: 13/348,817

(22) Filed: Jan. 12, 2012

(51) Int. Cl. G06Q 10/04

(52) U.S. Cl. 705/7.31

(57) ABSTRACT

A system provides automatic escalation of demand parameters to determine a reliable demand parameter for a level within a sales hierarchy. The system measures difference in demand parameters between a level of interest within the sales hierarchy and a plurality of other levels within the sales hierarchy. The system also compares the differences in demand parameters of the other levels. The system further determines an escalation path for a demand parameter based on the comparison.

### FIELD

One embodiment is directed generally to a computer system, and in particular to a system for providing automatic escalation of demand parameters.

### BACKGROUND INFORMATION

Economic analysis in retail science, and in similar endeavors such as wholesale science, can have many practical applications. For example, one area of study in retail science is the production of a forecast of sales units for merchandise to determine how many units of a particular piece of merchandise will sell in a particular time period.

The sales units of merchandise can be affected by many factors, such as seasonal factors. Seasonal factors can take into account things like temperature factors for clothing sales, but also other scheduled events that trigger purchasing, such as the Christmas shopping season for items purchased as gifts or the start of classes at the end of summer for items purchased for school.

Other factors can include whether a discount has been applied to the merchandise during the time period and at what point in the life cycle of the merchandise the time period falls. These are not an exhaustive list of factors.

These and other factors can be combined together to create a model for demand. The model for demand can then be used to intelligently suggest or reasonably select from those factors that are within the control of the retailer (in the case of retail science) or the manufacturer/distributor (in the case of wholesale science).

The model for demand can include demand parameters. However, determining the quality of demand parameters may not be completely intuitive. In particular, while it may be valuable to pool many disparate units together to obtain a demand parameter based on the most possible data, such a pool may not be as precise as a pool constructed only of similar units. A “pool” can refer to any group of units that are being treated or considered together with one another.

Relying on intuition or gut feeling to decide between richness and reliability can be imprecise and can lead to a lack of confidence regarding whether a substitute demand parameter for a pool that does not have a reliable demand parameter of its own is being reliably selected. “Richness” can refer to the amount of items in a pool, whereas “reliability” can refer to the predictive power of the items, that is, their similarity to an item of interest from the standpoint of the demand model. This approach may, therefore, be prone to error, and may require a relatively sophisticated user, thus limiting the user base of the software that calculates demand parameters.

### SUMMARY

According to certain embodiments, a computer readable medium has instructions stored thereon that, when executed by a processor, cause the processor to use escalation to determine a reliable demand parameter for a level within a sales hierarchy. The instructions include measuring difference in demand parameters between a level of interest within the sales hierarchy and a plurality of other levels within the sales hierarchy. The instructions also include comparing the differences in demand parameters of the other levels. The instructions further include determining an escalation path for a demand parameter based on the comparison.

### BRIEF DESCRIPTION OF THE DRAWINGS

FIG. 1 illustrates a block diagram of a computer system that can implement certain embodiments.

FIG. 2 illustrates pools according to certain embodiments.

FIG. 3 illustrates two-fold cross validation according to certain embodiments.

FIG. 4 is a flow diagram of the functionality of demand model module of FIG. 1 when determining an escalation path within a hierarchical set of pools of goods and/or services.

FIG. 5 is a flow diagram of the functionality of demand model module of FIG. 1 when determining an escalation path within a hierarchical set of pools of goods and/or services.

### DETAILED DESCRIPTION

One embodiment is a computer system that providing automatic escalation for demand parameters, through estimation of error in demand parameters.

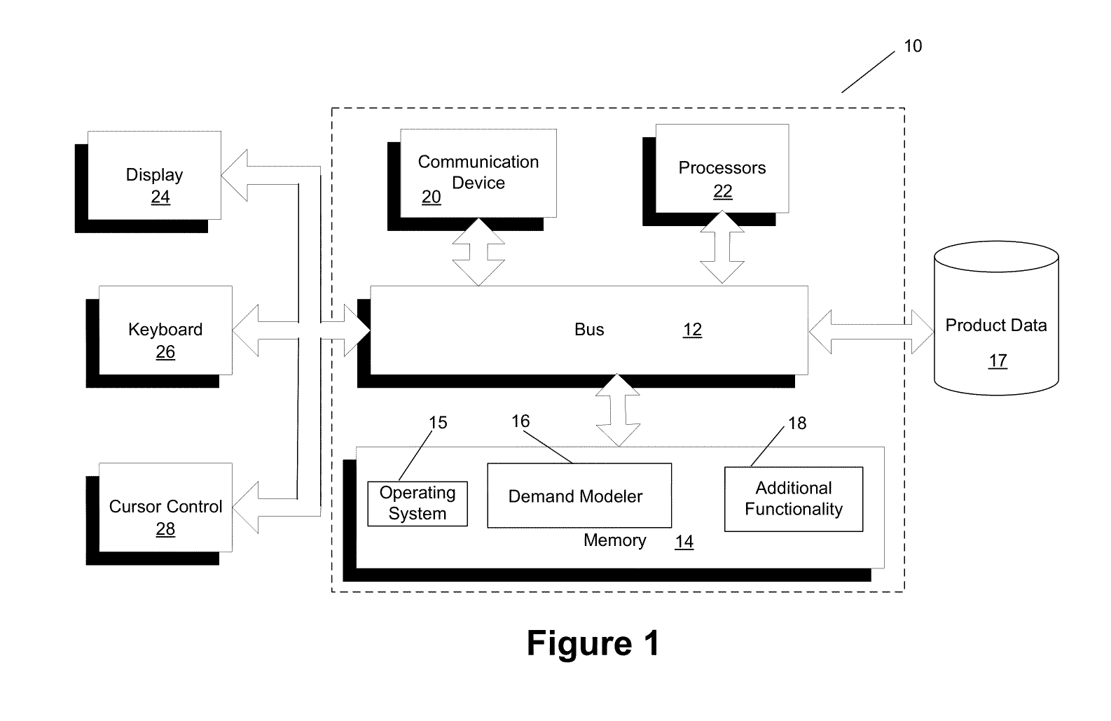

FIG. 1 is a block diagram of a computer system 10 that can implement certain embodiments. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor capable of processing multiple instructions in parallel. In one embodiment, processor 22 is an individual multi-core processor, but may be implemented using multiple individual processors in communication with each other, or any other type of processor or processors that is capable of parallel computing. In alternative embodiments, processor 22 may be an individual single-core processor.

System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. A non-transitory computer readable medium, for example, can be employed as the memory 14. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), plasma display, or cathode ray tube (“CRT”), for displaying information to a user. A keyboard 26 and a cursor control device 28, such as a computer mouse, touch screen, or trackball device, is further coupled to bus 12 to enable a user to interface with system 10.

In one embodiment, memory 14 stores software modules that provide functionality when executed by processor 22. The modules include an operating system 15 that provides operating system functionality for system 10. The modules further include a demand model module 16 that models demand for goods and/or services, such as the goods of a retailer. Collectively, a hierarchy of goods, services, or both can be referred to as a sales hierarchy. The hierarchy can be viewed as an arrangement of pools, with the smallest pools in the lowest levels of the hierarchy and the largest pools at the top of the heirachy. Thus, the demand model module 16 can be used, for example, to forecast the sale of goods. System 10 can be part of a larger system. Therefore, system 10 can include one or more additional functional modules 18 to include the additional functionality, for example, models for obtaining specific demand parameters. Examples of additional functional modules 18 can include “Retail Demand Forecaster,” “Markdown Optimizer,” and “Regular Price Optimizer” all from Oracle Corporation. A database 17 is coupled to bus 12 to provide centralized storage for modules 16 and 18. In certain embodiments, the database 17 may be a structured query language (SQL) or other relational database, and may store historical information regarding demand for various goods and services. Although one database 17 is shown, multiple databases may be included.

A causal demand model is one approach to forecasting sales units, although other demand models are also possible. For ease of explanation, the following discussion focuses on causal demand models, but it should be understood that the procedures and systems described do not have to be limited either to causal demand models or to the particular embodiments thereof, described below.

A causal demand model can be implemented in hardware or in the operation of software on hardware. A causal demand model can, for example, mathematically model sales units in various way. For example, a causal demand model can model sales units in terms of factors such as season, timing of discount within a period of selling of the merchandise, life cycle stage of the merchandise.

These and other factors, which are known, believed, or thought to affect demand for the merchandise are termed “demand variables” for the demand model. The model can specify mathematically how the demand variables affect sales units. For example, if the amount of discount is a demand variable in the model, the model may specify that a 50% price cut results in a 4-fold increase in sales units, that is to say, sales quadruple. Thus, with a causal demand model, it may be possible to forecast sales units by specifying the future values of the demand variables.

To continue the price-cut example, the retailer may plan to run a 40% sale during some weeks next season. The demand model can take this plan into account and forecast sales units for those weeks. Other possible sale percentages can also be used to forecast sales units during that time period. Assuming sale percentages have the effect of changing the expected demand, this information may help a retailer decide what sales percentage to select. The change in demand in response to a change in price is the item's price “elasticity,” a reflection and measure of the relevant market's responsiveness to changes in price. Some models may treat price elasticity as linear, however, generally price elasticity curves can take various shapes and can be modeled accordingly.

The demand model can determine (or be supplied with) a shape for this price elasticity curve. The shape for this curve can be determined according to the relationship of the demand variables to the sales units. This relationship can be referred to, in the context of the demand model, as the demand parameter associated with the demand variable.

The demand parameters can be initially unknown, and the demand model can be configured to provide the demand parameters. By accurate determination of demand parameters, more accurate sales forecasts can be achieved.

In the example given above, a 50% price cut results in a 4-fold increase in sales units. This is not simply an arbitrary selection of a value. Instead, the relationship between the discount demand variable and sales units is determined though a method of calculation. In particular, the demand parameter can be determined by examining historical data containing price cuts for the merchandise itself. The determination process is called “estimation,” and can involve estimation routines that examine the historical sales data and apply various statistical approaches.

Frequently, however, the merchandise itself has too little historical sales data for the routines to make a reliable estimate of the demand parameters. Moreover, there are mathematical and statistical reasons why estimation of demand parameters based only on a single item of merchandise can be impractical.

Thus, historical data of several items of merchandise can be pooled together, and an overall estimate of demand parameters can be made for all the items simultaneously. Thus, for example, the elasticity estimate represents a type of average elasticity over all of the several items of merchandise whose historical data has been pooled together. The items of merchandise are presumed to be similar, so that using an average elasticity over all of the items does not seriously misrepresent the elasticity of any particular item.

In one embodiment, the pooling of items is done in a structured and fixed way, using a hierarchy of “pools,” each pool containing the smaller pools below it in the hierarchy. This may be a sales hierarchy. Thus, for example, the bottom of the hierarchy may contain pools with only a few items in it, while at the top of the hierarchy is one giant pool containing all of the merchandise sold by the retailer at any of its stores. In between are intermediate pools such as department-level pools, which contain all of the items in a specific department of the retailer. The hierarchy of pools can be specific to each retailer, and can serve as an organizational principle of the retailer's business. The “level” of a pool is the level of the pool within this hierarchy (for example “department level”). Each level of the hierarchy contains multiple pools. For example, the Department level has one pool for each Department. Similarly, the Sub-class level would have one pool for each sub-class. The pools can also be referred to as partitions.

In one embodiment, a lowest level is the stock keeping unit (SKU) level. The SKU level can have a vast number of partitions, with each partition being a single item. The next level can be, for example, a color level. The color level can have numerous partitions with each partition including a pool of a single color, which may contain many or few SKUs, depending on the number of items of that particular color. The style level can be above the color level. Above that can be a sub-class level, such as “men's belts.” Then, above that level, there can be a class level, like “men's goods.” The levels can continue with a department level followed by a division level. The demand parameters can be calculated at each level.

Other structured and fixed hierarchies are also possible. For example, a geographical hierarchy of zip code, city, county, state, country, and continent can be used to organize points of sale. Thus, the particular hierarchy used as an example in this discussion should not be considered the only possible hierarchy.

The more items that are pooled together, the less representative the estimated elasticity is likely to be of any particular item. Thus, in an ideal case, estimates are produced by performing them within each of the smallest, lowest-level pools. Accordingly, each pool receives its own estimate unaffected by the other pools.

Many of the lowest-level pools, however, may also have too few items or too little historical data to make a reliable estimate of demand parameters that is specific to the pool. Nonetheless, the items in such a pool may need forecasts, and hence may need demand parameters.

Consequently, a structured way to enlarge the smallest pools in order to produce demand parameters that are as representative as possible of the small pool may be needed. This structured way of moving to larger pools is known as the “escalation path.” The escalation path is a sequence of levels, starting at the lowest, indicating the hierarchy of pools to try when obtaining estimates for a lowest-level pool. The estimates that are to be used by the demand model may be the first ones (along the escalation path) that are reliable. Thus, an escalation path can be used in a case where demand parameters at a given level are not reliable.

One escalation path is simply based on a rule of thumb that the best approximation to a lowest-level pool is the next smallest containing pool In this case, the escalation path simply consists of going from each level to the next higher level.

This intuitive approach, however, may face various challenges. For example, identifying what the “next higher” level is may not be well-defined, because there can be several “next higher” levels. This may be because the hierarchy structure of the pools at a retailer is typically not a simple tree structure. Additionally, the “next higher” pool is sometimes in fact not the best approximation. A manual approach, in which a knowledgeable, sophisticated user specifies the escalation path based on analysis and knowledge of the retailer's business is one way to address these challenges. However, certain embodiments can eliminate the need for a manual approach.

Certain embodiments, for example, measure the difference between the demand parameters at higher levels and the demand parameters at the lowest level. The level that shows the smallest difference becomes the first level for escalation, that is, the first level to which to escalate. The level that shows the second smallest difference becomes the second level to which to escalate, and so on. While this progression is referred to as “escalation,” it should be noted that the progression is not necessarily one that is always to a higher level, as will be seen in the following examples.

Table 1, below, provides an example of how differences between the lowest level and the other levels can dictate an escalation path. In this example, Style is the lowest level:

TABLE 1

| | Difference in demand |
|---|---|
| Style and other level | parameters |
| Between Style and Subclass | 5.0 |
| Between Style and Class | 4.3 |
| Between Style and Department | 6.4 |
| Between Style and Division | 7.2 |
| Between Style and Chain | 10.3 |

In this case, the escalation path is: Class, Subclass, Department, Division, and finally Chain, based on the measured difference in demand parameters. Thus, if a particular Style pool does not have reliable demand parameters, then the system goes to the Class pool that contains it. If the Class pool has reliable demand parameters, then those parameters can be used for the Style pool. If the Class pool does not have reliable demand parameters, then the system can try the Subclass pool that contains the Style pool, and so on through Department, Division, and Chain.

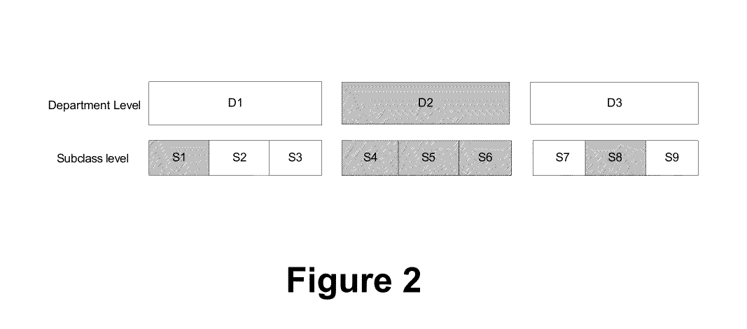

Thus, this methodology depends on measuring the difference in demand parameters between the lowest level (L1) and another level LN (where N can range from 2 to the total number of levels). The difference being measured can be the difference in demand parameters across all pool pairs (Q, P) where Q contains P and P is from L1 and Q is from LN and both Q and P have reliable demand parameters. FIG. 2 illustrates pools according to certain embodiments. Grey shading indicates that the pools do not have reliable demand parameters.

Taking FIG. 2 as an example, subclass may be the lowest level, and may consist of subclasses S1 through S9. Although in FIG. 2 subclass and department level, in general these can be examples of respective child and ancestor (for example, parent, grandparent, great-grandparent, and so forth) levels.

Measuring the difference in demand parameters between the Subclass level and the Department level can mean measuring the difference between the departments and each of the subclasses contained in each department. For department D1, that would involve determining the differences between D1 and S2 and D1 and S3. S1 is not considered because it does not have demand parameters or, at least, does not have demand parameters that are deemed reliable. D2 is not considered at all since it does not have reliable demand parameters. Then, all of the differences across all of the departments and their subclasses can be accumulated by the system. The accumulated difference is then the difference in demand parameters between Subclass and Department levels, and can go into a table, like table 1 above.

Thus, measuring the difference between the lowest level and another level can be considered, at a rudimentary level of analysis, to be measuring the difference between a lowest-level pool P and a pool Q at a higher level, where Q contains P. Specifically, in the example above, measurement is made of the difference between a particular ancestor department, for example D1, and a subclass or child within at same department, for example, S2. There is no requirement that the two levels be adjacent levels.

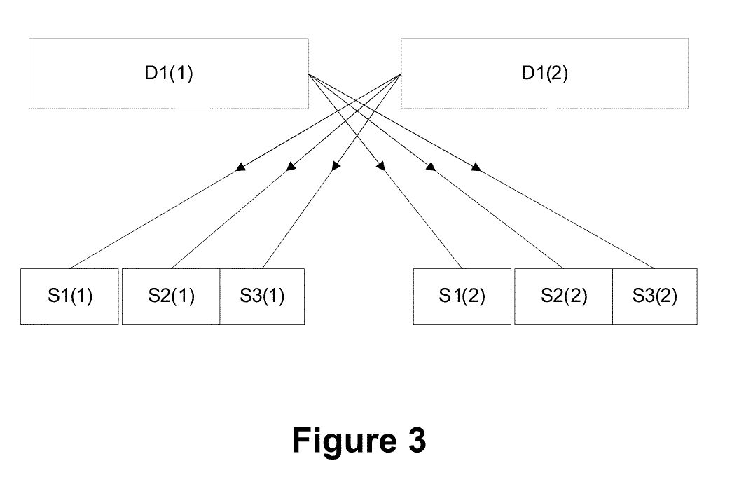

In one embodiment, the difference between two pools is measured using a technique called “two-fold cross validation.” This technique involves splitting a pool into two parts and calculating demand parameters for each part separately. FIG. 3 illustrates two-fold cross validation according to certain embodiments. In particular, FIG. 3 shows a 2-fold cross validation on D1 vs. its subclasses S1 through S3.

As shown in FIG. 3, the pools at the lowest level (Subclass) can each be split into two pools. S1 is, in this example, split into S1(1) and S1(2), and similarly S2 and S3 are split. The Department D1 can also be split into two pools D1(1) and D1(2), with the split being determined from the Subclass split, such that D1(1) is the union of S1(1), S2(1), and S3(1) and D1(2) is the union of S1(2), S2(2), and S3(2). A random technique can be used, thereby selecting the split pools at random.

After the splitting, demand parameters can be calculated for each of the pools in the diagram. A cross comparison of the demand parameters can be performed. The arrows in FIG. 3 show how the cross comparisons are done. For example, the demand parameters for D1(1) are compared with those of S1(2), S2(2), and S3(2). A single number, called the mean squared error, can then summarize the results of the cross comparison for D1 vs. its subclasses. Cross validation can then be performed on D2 and D3 of FIG. 2 in a similar manner. Combining the results of all of these cross comparisons together gives a single number comparing Department to Subclass. This single number is the number that can be placed in the column “Difference in Demand Parameters” in table 1 above, or any similar table. A formula for calculating the mean squared error is as follows:

$$error ( subclass , department ) = \sqrt{\frac{{\sum }_{D ∈ department} {\sum }_{S ∈ subclass} [ {( S ( 1 ) - D ( 2 ) )}^{2} + {( S ( 2 ) - D ( 1 ) )}^{2} ]}{{\sum }_{D ∈ department} {\sum }_{S ∈ subclass} 2}} . \qquad ( Equation 1 )$$

Of course, this is just an example with Department and Subclass, but the same formula can be applied to other pools.

In the formula above, D runs over the departments, encompassing them all. Thus, in keeping with the above example, D would be D1, D2, and D3. S runs over the subclasses that are in a particular department, encompassing each of the subclasses of that department. For the department D1, for example, S would run over S1, S2, and S3, whereas for department D2, S would run over S4, S5, and S6.

The denominator is simply the number of terms in the summation in the numerator. This provides a way to normalize the error so that comparison of errors is meaningful, since different levels could have different numbers of terms in the numerator.

The cross comparison technique is a technique for measuring predictive power. In this case, the predictive power of interest may be the power of the demand parameters for D1 to predict the demand parameters for its subclasses. By construction, D1-1 is disjoint from S1-2. Thus, D1-1 has no knowledge of S1-2. Consequently, comparing D1-1 to S1-2 is a true test of the predictive power of D1-1 for S1-2. Comparing D1-1 to S1-1 would not be a true test, because D1-1 contains S1-1, and so its demand parameters already incorporate information about S1-1.

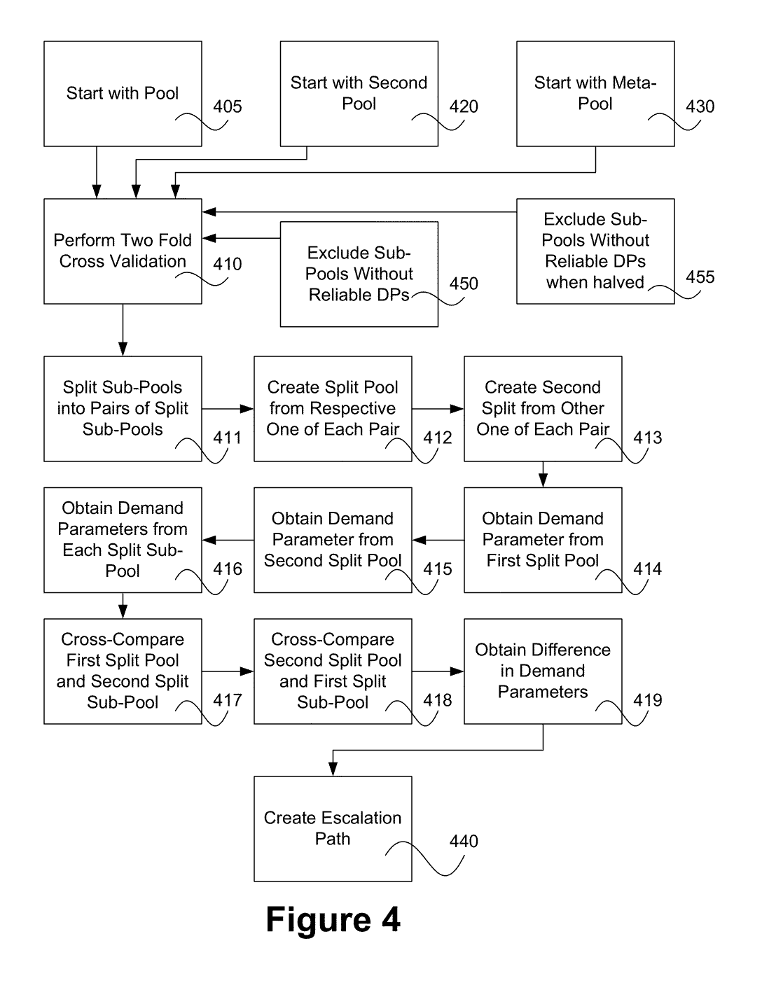

FIG. 4 illustrates a method according to certain embodiments. More specifically, FIG. 4 is a flow diagram of the functionality of demand model module 16 of FIG. 1 when determining an escalation path within a hierarchical set of pools of goods and/or services. In one embodiment, the functionality of the flow diagram of FIG. 4 is implemented by software stored in memory or other computer readable or tangible medium, and executed by a single processor or multiple processors in parallel. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

As shown in FIG. 4, the functionality can begin with starting from a pool, at 405. The functionality can include, at 410, performing two fold cross validation on the pool for a plurality of sub-pools. The two fold cross validation can include, at 411, splitting a plurality of sub-pools of a pool into pairs of partial sub-pools to form a plurality of split sub-pools. The splitting of the sub-pools can be performed randomly. FIG. 3 illustrates an example of such splitting and cross validation, in which D1 is a pool, and S1, S2, and S3 are sub pools.

The two fold cross validation can also include, at 412, creating a first split pool of a respective one of each pair of split sub-pools. Referring to FIG. 3, for example, D1(1) can be a split pool made up of respective split pools S1(1), S2(1), and S3(1).

The two fold cross validation can further include, at 413, creating a second split pool of the other respective one of each pair of split sub-pools. For example, referring to FIG. 3, D1(2) can be made up of S1(2), S2(2), and S2(3).

The two fold cross validation can additionally include, at 414, obtaining a demand parameter of the first split pool. For example, a demand parameter can be obtained for D1(1) in FIG. 3. The two fold cross validation can also include, at 415, obtaining a demand parameter of the second split pool (for example, D1(2) in FIG. 3). The two fold cross validation can further include, at 416obtaining demand parameters of each of the split sub-pools. Thus, for example, a demand parameter can be calculated for each of S1(1), S1(2), S2(1), S2(2), S3(1), and S3(2).

The two fold cross validation can additionally include, at 417, cross comparing the demand parameter of the first split pool with the demand parameters of the split sub-pools associated with the second split pool. In FIG. 3, for example, this cross comparison is illustrated using diagonal downward lines from left to right. The two fold cross validation can also include, at 418, cross comparing the demand parameter of the second split pool with the demand parameters of the split sub-pools associated with the first split pool. In FIG. 3, this cross comparison is illustrated using diagonal downward lines from right to left.

The two fold cross validation can further include, at 419, obtaining a difference in demand parameters of a level of the pool for a level of the sub-pools, based on the cross comparing, wherein the pool and sub-pools correspond to retail goods or services. The obtaining the difference can include calculating a mean squared error. For example, Equation 1 can be used for this purpose.

The functionality can further include, at 420, performing the two fold cross validation on a second pool for a plurality of second sub-pools, wherein the second pool and second sub-pools correspond to retail goods or services. A meta-pool can include the pool and the functionality can additionally include, at 430, performing the two fold cross validation on the meta-pool for a plurality of third sub-pools of the meta-pool, wherein the meta-pool and sub-pools correspond to retail goods or services. Thus, for example, a meta-pool can be any ancestor of the pool. The sub-pools of the metal-pool can be at a same level as the sub-pools of the pool (at 405).

The functionality can also include, at 440, creating an escalation path for one of the sub-pools based on the difference in demand parameters. The functionality can further include, at 450, excluding from the two fold cross validation sub-pools from which a reliable demand parameter (DP) cannot be obtained. Moreover, the functionality can include, at 455, excluding from the two fold cross validation sub-pools from which a reliable demand parameter cannot be obtained when the sub-pools are halved.

The functionality of FIG. 4, for example 411-419 can be performed in a different order than shown. For example, obtaining the demand parameters for each of the split sub-pools can be performed prior to obtaining a demand parameter of the first split pool. Additionally, the two fold cross validation for a second pool or meta pool can be performed before or in parallel with the two fold cross validation on the pool.

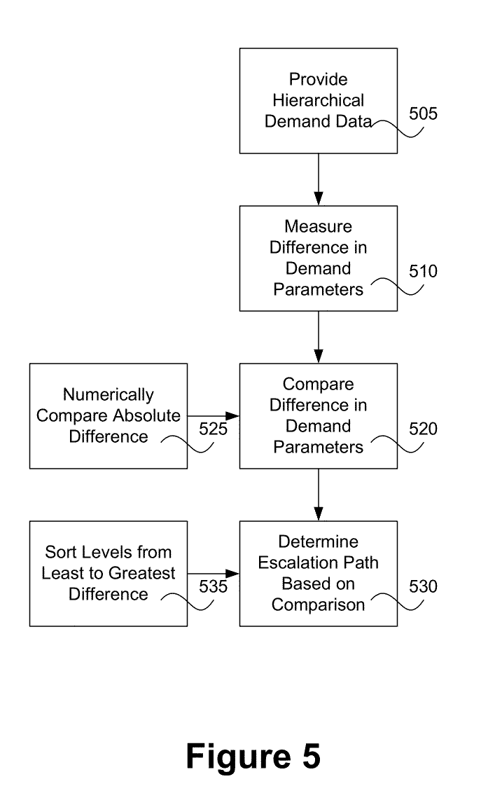

FIG. 5 illustrates a method according to certain embodiments. More particularly, FIG. 5 is a flow diagram of the functionality of demand model module of FIG. 1 when determining an escalation path within a hierarchical set of pools of goods and/or services.

As shown in FIG. 5, the functionality can include, at 505, providing hierarchical demand data for a sales hierarchy that includes multiple levels. This data may be stored in a database. This data may be sales level arranged in pools, for example pools ranging from SKU level pools, to division level pools, or any other hierarchy, such as a geographical hierarchy. The hierarchy shown in FIG. 2 may be an example of the sales hierarchy.

The functionality can also include, at 510, measuring difference in demand parameters between a level of interest within the sales hierarchy and a plurality of other levels within the sales hierarchy. The plurality of other levels can be all of the other levels, or a subset of them, such as levels within a predetermined range from the level of interest. The measuring of the difference in the demand parameters can be performed in any desired way including, for example, as shown in FIG. 4. Two of the levels of an example hierarchy are shown in FIGS. 2 and 3, but other levels can also be present.

As illustrated in FIG. 5, the functionality of the demand model module of FIG. 1 can further include, at 520, comparing the differences in demand parameters of the other levels. The comparing can include, at 525, numerically comparing an absolute difference in the demand parameters. For example, Table 1, above, provides an example of a listing of differences of demand parameters at various levels.

At 530, the functionality can include determining an escalation path for a demand parameter based on the comparison. The determination of the escalation path can include, at 535, sorting the levels from least difference (being the first level of the escalation path) to greatest difference (being the last level of the escalation path). For example, in Table 1, the least difference is between style and class (4.3), whereas the greatest difference is between style and chain (10.3). Thus, if Table 1 were sorted, the order of levels would be class, subclass, department, division, and chain.

Thus, as outlined above, a computer system can provide automatic escalation for demand parameters using measurement of difference in demand parameters. Certain embodiments, therefore, are applicable to any existing situation where demand parameters are already being calculated. If code is used to calculate demand parameters, it is not necessary to alter the code that calculates the demand parameters, as long as it can be called as a subroutine for the purposes of two-fold cross validation.

Although demand parameters used for forecasting are certain embodiments, the technique and systems described can apply to any calculation of demand parameters, whether used for forecasting or for some other purpose. In fact, models similar to demand models can be used in many areas other than retail science. Thus, certain embodiments can be used in a wide range of models that use pooling of data at multiple levels.

Certain embodiments can be implemented in a way that is mathematically uncomplicated. Thus, certain embodiments do not require complex code or third party libraries. Moreover, certain embodiments can be implemented in structured query language (SQL) and can thus run directly in a database, such as a relational database, giving the technique performance and scalability.

A simple but rigorous approach of automating the specification of the escalation path can remove a potential source of error in estimation. It can also enable less sophisticated users to employ software that calculates demand parameters. Other benefits include decreasing the implementation cost of employing demand parameters and producing consistent and repeatable results for a given set of data.

Thus, certain embodiments provide a simple, automated, and highly scalable, SQL-friendly approach to determining the optimal escalation path and, as a result, significantly improve predictive power of demand models. Such embodiments can apply, for example, to any product that calculates demand parameters and uses hierarchical pooling of data. Moreover, embodiments can be used in a variety of applications beyond retail, since models similar to the demand models of retail science can be used in many areas outside of retail.

While the embodiments disclosed above apply a relatively simple technique, other techniques may also be used. For example, Markov Chain Monte Carlo can be applied.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, causes the processor to use escalation to determine a reliable demand parameter for a level within a sales hierarchy, the instructions comprising:
measuring difference in demand parameters between a level of interest within the sales hierarchy and a plurality of other levels within the sales hierarchy;
comparing the differences in demand parameters of the other levels; and
determining an escalation path for a demand parameter based on the comparison.

2. The computer readable medium of claim 1, wherein the determining the escalation path comprises sorting levels from least difference in demand parameters to greatest difference in demand parameters.

3. The computer readable medium of claim 1, wherein the measuring the difference in demand parameters comprises:
performing two fold cross validation on a pool for a plurality of sub-pools, wherein the two fold cross validation comprises
splitting a plurality of sub-pools of a pool into pairs of partial sub-pools to form a plurality of split sub-pools;
creating a first split pool of a respective one of each pair of split sub-pools;
creating a second split pool of the other respective one of each pair of split sub-pools;
obtaining a demand parameter of the first split pool;
obtaining a demand parameter of the second split pool;
obtaining demand parameters of each of the split sub-pools;
cross comparing the demand parameter of the first split pool with the demand parameters of the split sub-pools associated with the second split pool;
cross comparing the demand parameter of the second split pool with the demand parameters of the split sub-pools associated with the first split pool; and
obtaining a difference in demand parameters of a level of the pool for a level of the sub-pools, based on the cross comparing, wherein the pool and sub-pools correspond to retail goods or services.

4. The computer readable medium of claim 3, wherein the obtaining the difference comprises calculating a mean squared error.

5. The computer readable medium of claim 3, the instructions further comprising:
performing the two fold cross validation on a second pool for a plurality of second sub-pools, wherein the second pool and second sub-pools correspond to retail goods or services.

6. The computer readable medium of claim 3, wherein a meta-pool comprises the pool, the instructions further comprising:
performing the two fold cross validation on the meta-pool for a plurality of third sub-pools of the meta-pool, wherein the meta-pool and sub-pools correspond to retail goods or services.

7. The computer readable medium of claim 3, the instructions further comprising:
excluding from the two fold cross validation sub-pools from which a reliable demand parameter cannot be obtained.

8. The computer readable medium of claim 3, the instructions further comprising:
excluding from the two fold cross validation sub-pools from which a reliable demand parameter cannot be obtained when the sub-pools are halved.

9. A computer implemented method to use escalation to determine a reliable demand parameter for a level within a sales hierarchy, the method comprising:
measuring difference in demand parameters between a level of interest within the sales hierarchy and a plurality of other levels within the sales hierarchy;
comparing the differences in demand parameters of the other levels; and
determining an escalation path for a demand parameter based on the comparison.

10. The computer implement method of claim 9, wherein the plurality of other levels comprise all other levels in the sales hierarchy.

11. The computer implement method of claim 9, wherein the measuring the difference in demand parameters comprises:
performing two fold cross validation on a pool for a plurality of sub-pools, wherein the two fold cross validation comprises
splitting a plurality of sub-pools of a pool into pairs of partial sub-pools to form a plurality of split sub-pools;
creating a first split pool of a respective one of each pair of split sub-pools;
creating a second split pool of the other respective one of each pair of split sub-pools;
obtaining a demand parameter of the first split pool;
obtaining a demand parameter of the second split pool;
obtaining demand parameters of each of the split sub-pools;
cross comparing the demand parameter of the first split pool with the demand parameters of the split sub-pools associated with the second split pool;
cross comparing the demand parameter of the second split pool with the demand parameters of the split sub-pools associated with the first split pool; and
obtaining a difference in demand parameters of a level of the pool for a level of the sub-pools, based on the cross comparing, wherein the pool and sub-pools correspond to retail goods or services.

12. The computer implemented method of claim 11, wherein the obtaining the difference comprises calculating a mean squared error.

13. The computer implemented method of claim 11, the instructions further comprising:
excluding from the two fold cross validation sub-pools from which a reliable demand parameter cannot be obtained.

14. The computer implemented method of claim 11, wherein the splitting of the plurality of sub-pools is performed randomly for each sub-pool.

15. A demand modeler, comprising:
a processor; and
a computer readable medium coupled to the processor;
wherein the processor, when executing instructions stored on the medium, use escalation to determine a reliable demand parameter for a level within a sales hierarchy, the reliable demand parameter determination comprising:
measuring difference in demand parameters between a level of interest within the sales hierarchy and a plurality of other levels within the sales hierarchy;
comparing the differences in demand parameters of the other levels; and
determining an escalation path for a demand parameter based on the comparison.

16. The demand modeler of claim 15, wherein the comparing the differences comprises numerically comparing absolute differences amongst the levels.

17. The demand modeler of claim 15, wherein the measuring the difference in demand parameters comprises:
performing two fold cross validation on a pool for a plurality of sub-pools, wherein the two fold cross validation comprises
splitting a plurality of sub-pools of a pool into pairs of partial sub-pools to form a plurality of split sub-pools;
creating a first split pool of a respective one of each pair of split sub-pools;
creating a second split pool of the other respective one of each pair of split sub-pools;
obtaining a demand parameter of the first split pool;
obtaining a demand parameter of the second split pool;
obtaining demand parameters of each of the split sub-pools;
cross comparing the demand parameter of the first split pool with the demand parameters of the split sub-pools associated with the second split pool;
cross comparing the demand parameter of the second split pool with the demand parameters of the split sub-pools associated with the first split pool; and
obtaining a difference in demand parameters of a level of the pool for a level of the sub-pools, based on the cross comparing, wherein the pool and sub-pools correspond to retail goods or services.

18. The demand modeler of claim 17, wherein the demand modeler is configured to obtain the difference by calculating a mean squared error.

19. The demand modeler of claim 17, wherein a meta-pool comprises the pool, the demand parameter error determination further comprising:
performing the two fold cross validation on the meta-pool for a plurality of third sub-pools of the meta-pool, wherein the meta-pool and sub-pools correspond to retail goods or services.

20. The demand modeler of claim 17, the demand parameter error determination further comprising:
excluding from the two fold cross validation sub-pools from which a reliable demand parameter cannot be obtained.
